(19) United States
(12) Patent Application Publication
(10) Pub. No.: US 2005/0125497 A1
(43) Pub. Date: Jun. 9, 2005

(54) Shareable log book system for amateur radio

(76) Inventor: Dennis Lyle Hevener, Auburn, GA (US)

Correspondence Address: Dennis Lyle Hevener, 1323 Center Dr, Auburn, GA, 30011, US

(21) Appl. No.: 11/006,255

(22) Filed: Dec. 7, 2004

Related U.S. Application Data
(60) Provisional application No. 60/527,942, filed on Dec. 8, 2003.

(51) Int. Cl. G06F 17/60

(52) U.S. Cl. 709/205; 705/1

(57) ABSTRACT

An awateur radio station with a computerized logbook (20) may look at data in other ham radio operators' logbooks (20) by submtting a request (22). The request travels over a data paths to all other stations (21). Any stations having records matching the reqest sends the log records matching the request (23) back to the requestor (22). A storage device (24) permits this system to operate in non-real-time mode—i.e. Users do not have to be online simultaneously.

### CROSS-REFERENCE TO RELATED APPLICATIONS

Not Applicable

### BACKGROUND

1. Field of Invention

This invention relates to an invention that allows users of computerized ham radio logging systems to view logbook entries of other users via a network.

2. Description of Prior Art

1. Since the beginning days of amateur radio, operators have exchanged post cards, known in the amateur community as QSL cards, as proof of contacting each other. QSL Routes, which tell how to send a physical or electronic QSL to different stations, are listed in many paper and online publications. This information may reference the direct mailing address of the station, or contact information for an agent who handles the confirmations for him or her.

2. After an operator works a desirable station—one that is in a country that is difficult to contact because of the few number of amateurs there for example—he or she may alert other stations via a short-range VHF voice transmission, an radio data network, or over the internet. This practice is known as Spotting.

My invention achieves the objectives of QSL Routes and Spotting, but in a different way with results that are in many respects superior.

3. One reason for keeping a log is to track progress towards various achievement awards—talking to another operator in every state or in a hundred or more different countries, for instance.

In order to obtain most awards, proof of claimed contacts must be provided to the organization issuing the award. Currently, there are electronic QSL cards that serve as proof of contact. An operator simply uploads his log to a central location, and anyone who has worked this operator may prove he did so by querying the database to see if his callsign is listed in the uploaded records. The two systems in common use is Logbook of the World (www.arrl.org) and eQSL (www.eqsl.net). These electronic logbook databases may at first appear to be similar to my invention. However, the purpose of my invention is not to provide proof of contact, and the operation and results of my software machine is quite different. Users of Electronic QSL databases merely upload their entire log to a central location. Users may only download log records that resulted from a contact with them. They do not permit viewing other's logs at will. Electronic QSL databases keep only very basic information necessary to prove the contact took place—the callsigns of the two operators, the radio band on which the contact occurred, the modulation mode, and the date and time that the contact occurred. My invention permits querying any log info of any participating member using any selection criteria. Current Electronic log databases are stored at a central location, and become huge. My system stores the shared log data on the computer of the person requesting it.

### SUMMARY

A system that allows amateur radio operators to view the log book entries of other amateurs over a network.

Objects and Advantages

Accordingly, besides the objects and advantages of existing QSL Route lists, and Spotting:
(a) Advantages over existing QSL Route Lists
   a. Current QSL Route Lists depend on someone voluntarily and accurately reporting the information. My invention does not require any action on the part of the person who has the information.
   b. Current QSL Route Lists do not show if the stated information was successfully used to obtain a confirmation. My invention permits the requester to view the QSL Received information for the station and route in question to see if a card was actually received or not, and determine how long it took to receive said card. Furthermore, the requester can compare log records from different users as additional confirmation that the data is correct.
(b) Advantages over existing Spotting operations.
   a. Current spotting operations require that the user take action to post spots. My system requires no action on the part of the operator who has the desired data.
   b. With traditional spotting operations, a spotter posts what he feels may be valuable to others. My system allows the requester to specify the data that he is interested in.
   c. Current spot data contains only brief information—the callsign of the station that was heard, his operating frequency, and an optional short comment. My system retrieves a complete log records, which will probably contain other useful information, such as the contact information for the station, notes about equipment used, etc.

### DRAWING FIGURES

FIG. 1 shows a conceptual overview of the system.

FIG. 2 shows the major operational processes of the system.

FIG. 3 is a program flowchart for updating the User's Request File from the Server's Request File.

FIG. 4 is a program flowchart for sending log data from User to Server.

FIG. 5 is a program flowchart for submitting user request to server and sending log data from Server to User.

### REFERENCE NUMERALS IN DRAWINGS

20 Amateur radio station with computerized logbook, connected to a data network.
21 Two-way logical data path between all stations logged onto the system.
22 A request for data sent by one user to another.
23 Results data answering request.
24 File server, with software to store and forward requests and log data.

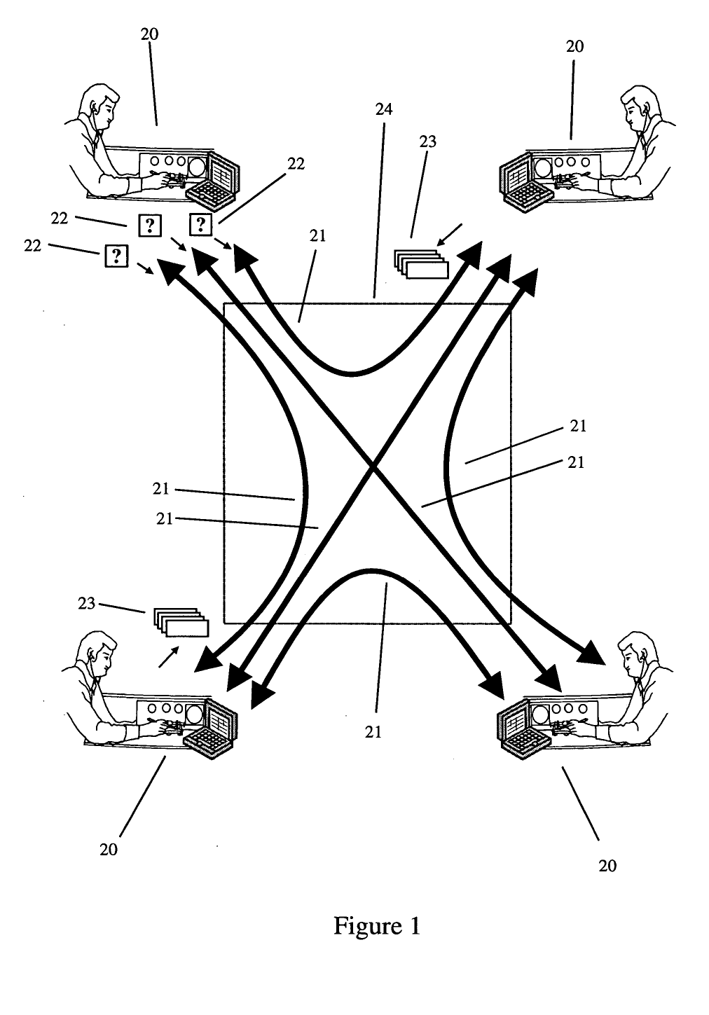

### DESCRIPTION—FIG. 1

FIG. 1 is a conceptual overview of the system. Amateur radio stations with computerized logging (20) may all request, download and view data from the log file of any other member of the system via a network of logical data paths (21). Four amateur radio stations (20) are shown here. However, any number of stations may use the system. A user begins the process of looking at another's data by sending a request (22) to all other members. If members have log data (23) that match the request (22), it will be returned. So that the system will function without members being logged into the system simultaneously, a file server with specialized software (25) stores requests and resulting log data for retrieval and processing as various amateur radio stations (20) log in. The server (24) also routes requests (22) and results (23).

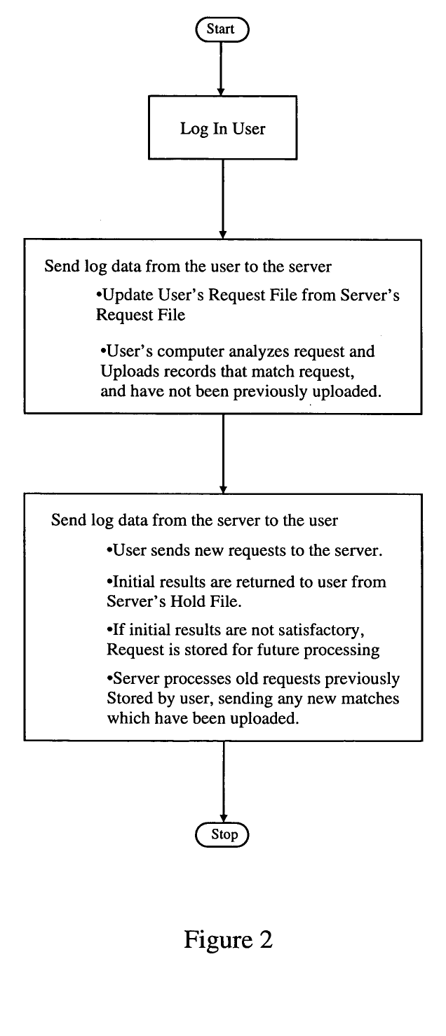

### DESCRIPTION—FIG. 2

FIG. 2 shows major operational processes of the system.

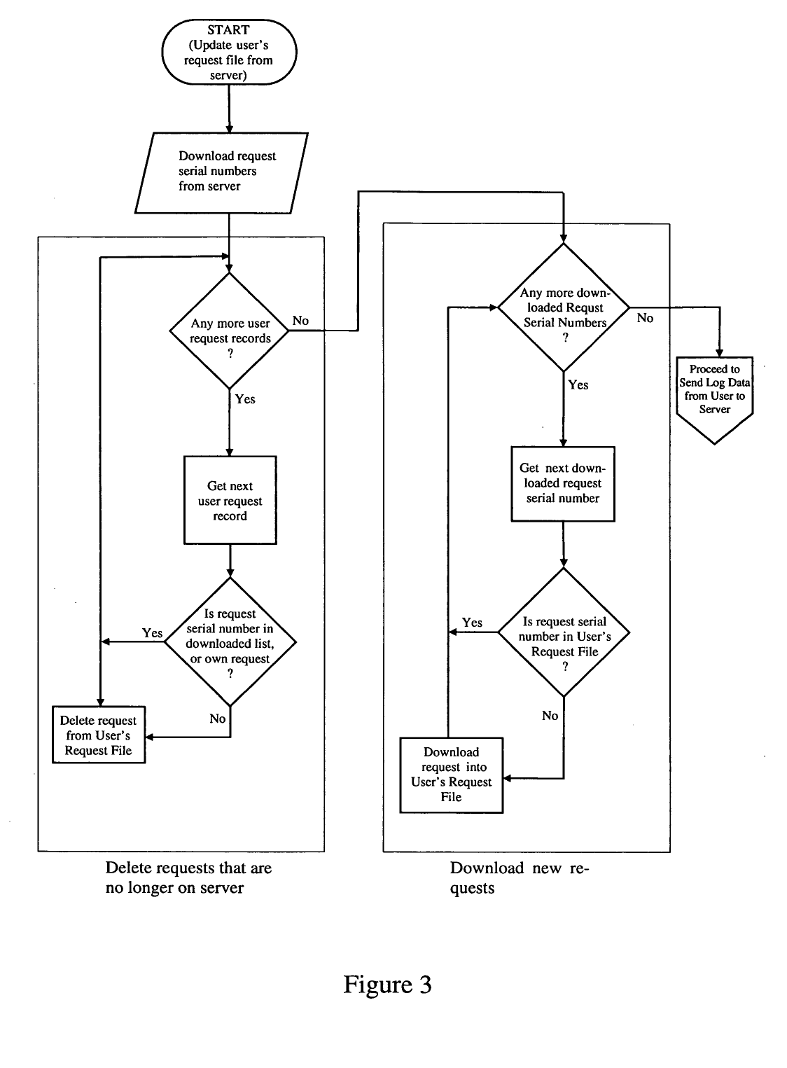

### DESCRIPTION—FIG. 3

FIG. 3 details the process of updating. The User's Reqest File from the Server's Request File. The users own requests are not deleted by this process, since they correspond with downloaded results.

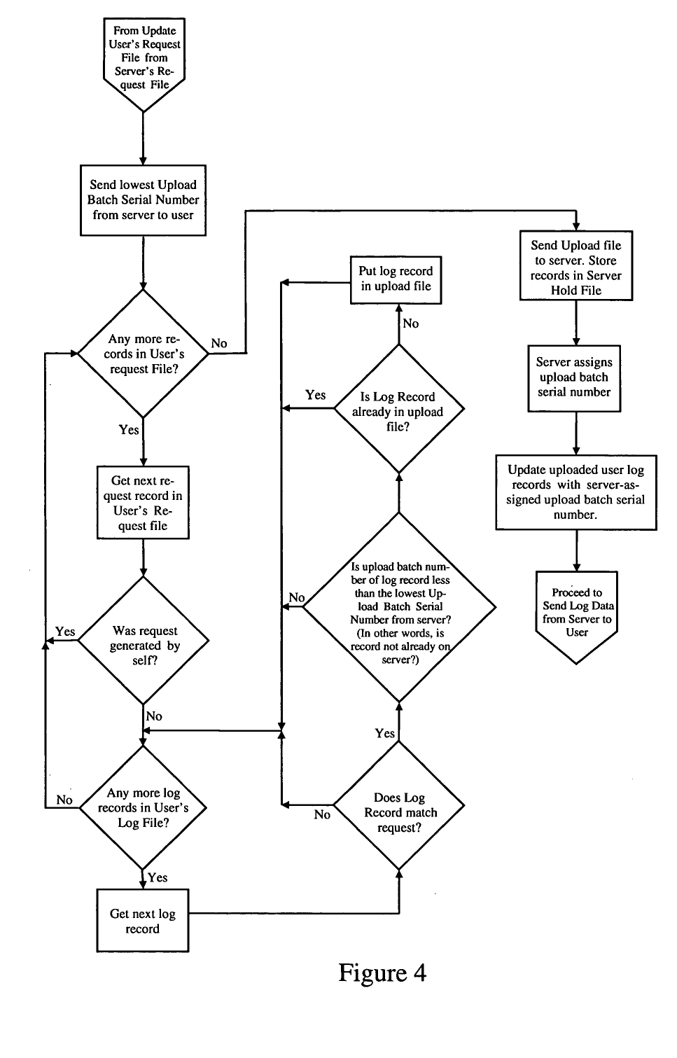

### DESCRIPTION—FIG. 4

FIG. 4 details the process of sending User's log data to the server, to be stored and forwarded to other users who requested it.

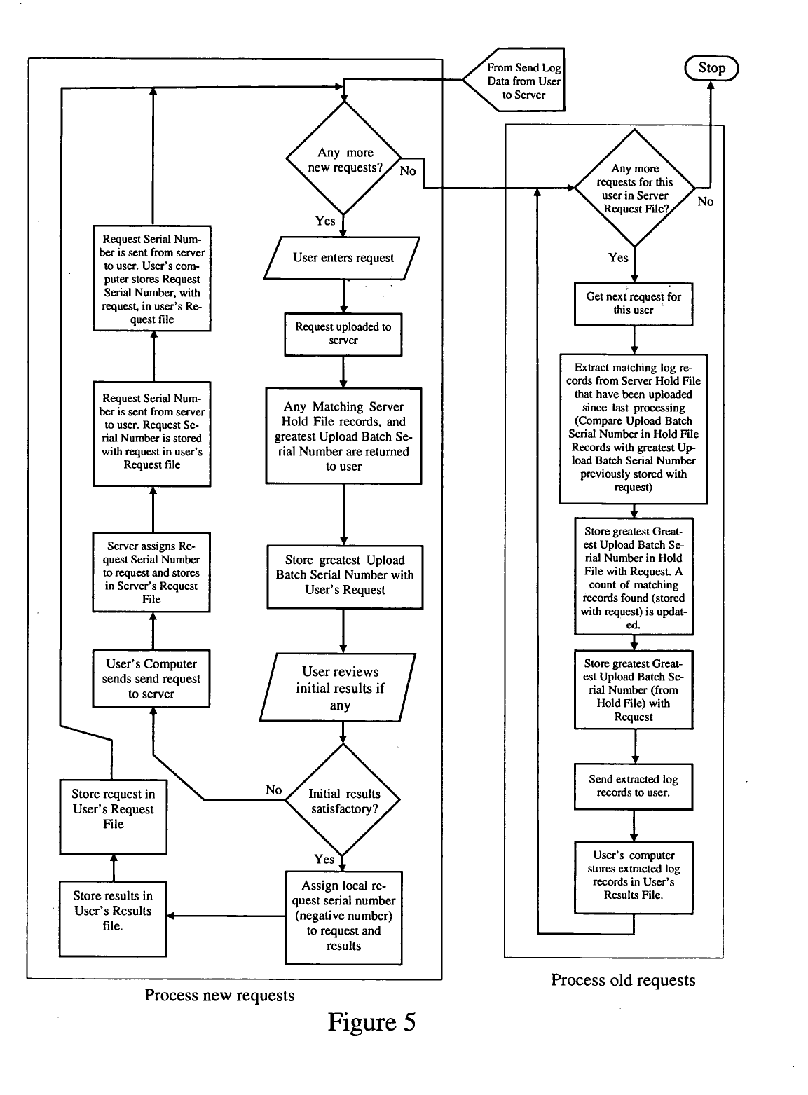

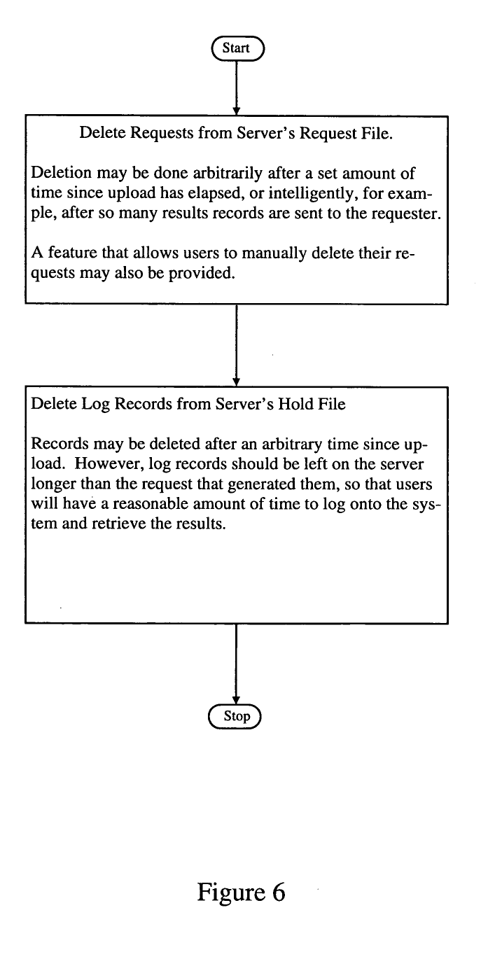

### DESCRIPTION—FIG. 5

FIG. 5 details the process of sending log data from the Server to the User in response to User's requests. When a request is first uploaded, the server returns any matching data that it is holding. The user reviews these results. If they are satisfactory, no further action is necessary. If the initial results are not satisfactory, the Server stores the request to send to other users, with hopes that these other users will have data matching the request.

### Programming Notes

Description of Data Files:
1. Users Log File—Contains usual log data, plus, for each record, an Upload Batch Serial Number. This field is set to zero when a record is created or modified, indicating the record has not been uploaded. When the record is uploaded, the Upload Batch Serial Number assigned by the server is sent back to the user, and stored here. This file resides on the user's computer.
2. Server's Hold File—this file is a holding place for uploaded user log records, so that requestors and providers do not need to be online simultaneously. This file contains the usual log data, plus an Upload Batch Serial Number that is incremented for each new batch uploaded. This file resides on the server.
3. Server's Batch File Master—contains date and user identifier of each batch uploaded to Server's Hold File. Keyed on serial number This file resides on the server.
4. Server's Request File—contains list of all requests. Fields: Request Serial Number, Select Criteria, Description, Requested by, Created date, and Upload Batch Serial Number of the most recent record used to fulfill the request. May also contain fields that are not necessary for operation, but useful for statistical purposes, such as number of people answering request, or the number of records answering request. This file resides on the server.
5. User's Request File—copy of the Server Request File, which resides on the user's computer.
6. User's Results File—log records downloaded to user. The usual log data, plus the Request Serial Number which generated the record.

Processing Overview

Here is an overview of the processes of which the system:
1. User logs into the server.
2. Send log data from the user to the server
   a. The Server's Request file is copied to the User's Request File.
   b. User's computer analyzes the requests, and uploads log records, if any, that match one or more requests to the Server's Hold File. Records that have already been uploaded and not yet deleted from the server are not uploaded again.
3. Send log data from the server to the user
   a. User sends new request(s) to the server.
   b. Initial results are returned from Server's Hold File. Upon reviewing the initial results, the user may delete the request
   c. If the initial results are unsatisfactory, the request is stored, in on hopes of obtaining more results in the future.
   d. Server processes old requests that were previously stored by the user (if any), sending matching log records from Server's Hold File to user. Only log records uploaded by other users since the last download are sent.

The scenario summarized above assumes the user logs into an established system that has already had at least one or more request uploaded by another user, and log records have been already been uploaded to fulfill requests. However, the same logic applies to the first user who logs onto the system. There are no requests on the server, so the user's computer does not find any matching log records to upload. Likewise, there are no log records on the server to be downloaded to the user. If the first user has a request, it will be stored in the Server's Request File, awaiting possible fulfillment by the second and subsequent user to log on.

Following is a detailed description with processing logic details of each step summarized above.

1. Login

The operator of this service may wish to make the system available on a subscription basis, or at least provide some sort of user validation so as to prevent anonymous users from uploading bogus data. If the user's user name and password are not on file, the user is alerted and disconnected from the server.

2. Send Log Data from the Server to the User

2a. Update User's Request File

The Server's Request File is copied to the User's Request File. Simply copying the entire request file is acceptable. However, network traffic will be decreased if the server first sends a list of request serial numbers to the user. The user's computer then deletes any records with serial numbers that are not in the list sent by the server. These records have been deleted from the server. Requests generated by the user may be left on-file and flagged as having been deleted from the server. These request records can be used when viewing log records in the User's Results File to see which request and select criteria generated the results.

The user's computer then downloads any records that are in the list, but not in the User's Request File. These records have been added since the user last downloaded the Request File. Note that in the event that the User's Request File is empty, either because it is the user's first time to log on, or because the User's Request File has somehow been erased, this method will effectively copy the entire Server's Request File to the User's Request File.

2b. Upload User's Log Data to Server

The server begins by sending the lowest batch serial number that exists in the Server's hold file. The user's computer processes the request file which was updated in the previous step by extracting all log records that: (1) match one or more request to a temporary file, and (2) have a upload batch number less than the lowest batch serial number sent by the server. A log record is extracted only once, even if it matches more than one request. Requests generated by the user are not processed. There is no need for a user to send himself his own data.

Upon receiving the uploaded data, the server assigns the next available Batch Serial Number to the upload. The Server's Hold File as follows: Each record in the uploaded data is compared to all records in the Server's Hold File. If the callsign, operator, and date/time which the contact occurred are the same for a given record, that record has already been uploaded to the server. This can happen if the date/time uploaded field in the User's Log File gets blanked accidentally, or the logging program blanks it purposely because the record has been changed. If the record has already been uploaded, the matching record in the Server's Hold File is updated from the uploaded data.

If the callsign, operator, and date/time which the contact occurred do not match any record currently in the Server's Hold File, a new record is created and the record is added to the Server's Hold File.

The Upload Batch Serial Number is recorded in each record that is added or updated in the Server's Hold File.

Finally, the Upload Batch Serial Number is sent back to the user. The User's computer updates the uploaded records in the User's Log File with the returned Upload Batch Serial Number.

3. Send Log Data from the Server to the User

Thus far we have discussed getting requested user log data to the Server's Hold File. Now we will discuss sending data from the Server's Hold File to the requesting user.

3a. User sends new requests to server

This process is begun when the user creates a request record. He enters a select criteria and a friendly description, which is uploaded to the server. The server then scans the Server's Hold File to find any matching records. If any matching records are found, these are sent to the User's Results File.

3b. Server sends initial results to user

The user may be given the opportunity to review these initial results. If they satisfy the user, the request may be discarded. However, if no records are found in the Server's Hold File, or the requester is not satisfied with them, processing continues as follows.

3c. Request is stored for future processing

The request is assigned a serial number and stored in the Server's Request File. The greatest Upload Batch Serial Number of any record provided in the initial results is stored in the request record. If no records are found when the request is submitted, zero is stored in the Most Recent Batch Sent field.

3d. Processing stored requests

When the user logs onto the server subsequent to uploading a request, the server scans the Server's Hold File for matching records, getting only records that have a greater Upload Batch Serial Number than the Most Recent Batch Sent that was previously stored with the request. The user's computer stores the results in the Users' Results File. The server stores the greatest Upload Batch Serial Number in the Server's Request File record.

When extracting records to send to the user, the same record may match more than one user request. The record could be downloaded multiple times, once for each request, with the request serial number added to the log record in the User's Results File. This permits the user to easily view which log records match each request.

Maintenance

In order to manage disk space usage and network traffic, a maintenance routine may delete records from the Server's Request File and Server's Hold File. However, the Server's Request File records should be kept at least long enough for a lot of users to log onto the system to potentially fill the request. Two weeks should cover most users who are active ham radio operators.

Records should not be deleted from the Server's Hold File until some time after the request that generated the record is deleted. This will give the requestor time to log on and retrieve his results before they are deleted. Additionally, by keeping a lot of records in the Server's Hold File, more new requests may be fulfilled immediately upon submission. On the other hand, old data is generally not going to be as useful as new data.

Record deletion on the server may be simply handled by deleting, for example, all requests after two weeks, and log records after say three weeks. Or, the number of uploaded log records matching the request could be monitored, and requests that generate few or no results could be left up longer. If a request has generated no results, it may be left on the server indefinitely, without having to be concerned about deleting matching log records. A request that generates a lot of results could be deleted sooner than normal.

1. An interconnected system system of computerized amateur radio logbooks, comprising a means of viewing logbook records from any or all other connected logbooks.

2. A means of storing requests and results so that the system in claim 1 can function even though participants are not connected simultaneously.
